(19) United States
(12) Patent Application Publication
(10) Pub. No.: US 2013/0039408 A1
(43) Pub. Date: Feb. 14, 2013

(54) METHOD FOR ENHANCING COMPRESSION AND TRANSMISSION PROCESS OF A SCREEN IMAGE

(71) Applicants: Dan Cohen, Rehovot (IL); Gilad Ben-Yossef, Rishon LeZion (IL)

(72) Inventors: Dan Cohen, Rehovot (IL); Gilad Ben-Yossef, Rishon LeZion (IL)

(73) Assignee: SCREENOVATE TECHNOLOGIES LTD, Raanana (IL)

(21) Appl. No.: 13/367,605

(22) Filed: Feb. 7, 2012

Related U.S. Application Data
(60) Provisional application No. 61/440,072, filed on Feb. 7, 2011.

(51) Int. Cl. H04N 7/26

(52) U.S. Cl. 375/240.01; 375/E07.076

(57) ABSTRACT

A method for enhancing compression and transmission process of a screen image that is generated by at least one application program that is running on a processing device is provided herein. The screen image is streamed from the processing device to a remote display. The method is utilizing in real time hint data from said application programs and the operating system. The hint data include: (i) usage of data device resources (per application); (ii) usage characteristics of an application image; (iii) application layout data; or (iv) application type. Then, using retrieved windows' layout design information of all windows that appear at the image screen from a windows manager and hint data to determine compression and transmission techniques of at least a part of an application program that is displayed on the screen image by applying predefined rules based on aggregated hint data per application program.

### TECHNICAL FIELD

The present invention relates to the field of compression and transmission techniques, and more particularly, to enhancing compression and transmission process of at least one application program that is displayed on a screen image of a processing device.

### BACKGROUND ART

Transmission of high quantity and high quality of image, graphical or video data requires efficient and economical compressing/encoding techniques. For that purpose, various compression techniques were developed. One of these compression techniques operates by regions of pixels. Each region of pixels contains a different type of data and therefore being compressed/encoded in a different compression technique that is the most effective to that type of data, as disclosed in U.S. Pat. No. 7,548,657 to David M. Deaven.

This type of compression technique does not take into account information that may be provided by an operating system or an application program in real time regarding usage type of an application. Also, this type of compression technique is determined only after a window is created and not during the time that the window is displayed.

### SUMMARY OF INVENTION

According to some embodiments of the present invention a method for enhancing compression and transmission process of a screen image generated by at least one application program running on a processing device is provided herein. The screen image is streamed from a processing device to a remote display, said method comprising the steps of: retrieving screen image data as generated by at least one application program;
retrieving in real time, hint data from at least one of the following: said application programs and the operating system, wherein said hint data include: (i) usage of data device resources (per application); (ii) usage characteristics of an application image; (iii) application layout data; or (iv) application type
retrieving windows' layout design information of all windows that appear at the image screen from a windows manager; and
determining compression and transmission techniques of at least a part of an application program that is displayed on the screen image by applying predefined rules based on aggregated hint data per application program.

According to some embodiments of the present invention, the usage characteristics of the application image includes identification of changes of the application image (frame), and respective rules including instructions to skip transmission of a frame image when no change is identified.

According to some embodiments of the present invention, identification of application image changes is achieved by hooking an Operating System (OS) mechanism which provides content related information of the application image.

According to some embodiments of the present invention, the identification of application image changes is achieved by OS hooks on User Interface (UI) framework such as views and control composing the application window and rules including instructions to skip partial areas of the application image in which no change is identified.

According to some embodiments of the present invention, the hint data includes application program usage type of the image screen and rules to select compression techniques based on usage type.

According to some embodiments of the present invention, application program usage includes transition operation related information and rules include instruction of changing compression and transmission parameters.

According to some embodiments of the present invention, the identification of transition operation is achieved by OS hooks in the User Interface (UI) framework of Android OS.

According to some embodiments of the present invention, the identification of transition operation is achieved by receiving application program's hint data.

According to some embodiments of the present invention, the identification of transition operation includes information of transition direction.

According to some embodiments of the present invention, the hint data include characteristics of optimal video quality of video which includes the screen image, and rules including transmission and compression instructions adapted to characteristics of optimal video quality.

According to some embodiments of the present invention, the characteristics of optimal video quality streaming are detected from an external network performance parameters, and the rules include calculation of the maximal frame rate and other related parameters in real time and adjust compression parameters accordingly.

According to some embodiments of the present invention, the characteristics of optimal video quality streaming are detected from OS hooks.

According to some embodiment of the present invention, an SDK API allows application programmers to define program parameters related to optimal image compression and transmission in advance and change these program parameters during application program execution, wherein these parameters are gathered in real time and used as hint data.

According to some embodiments of the present invention, the hint data includes repeating patterns in the screen images hooked from the OS and the applications and wherein the rules includes instructions for caching repeated patterns at the target display and identifying repeated patterns by reference number, hence the transmitted screen images excludes the repeating patterns and send only its reference number.

According to some embodiments of the present invention, information of repeating patterns in the screen images is received from OS hooks with no application program intervention.

According to some embodiments of the present invention, the hint data includes specific characteristic for each component or each application program that appears on the screen images and the compression rules are determined by at least one of: (i) optimizing the compression and transmission parameters; and (ii) screen images' quality by taking into account the hint data of all screens areas and application programs and OS hint information of windows layout, wherein the optimization include prioritizing between the compression and transmission parameters of the different components and applications and determining unified compression and transmission parameters for the whole screen image.

According to some embodiments of the present invention, different priorities are defined for all components and application programs that appear on the screen image.

According to some embodiments of the present invention, different priorities are calculated in real time according to hint data for all components and application programs that appear on the screen image.

According to some embodiments of the present invention, the transmission technique further includes splitting application windows compressing each application and transmitting to the client side and merging of all compressed images of application programs at the client side.

According to some embodiments of the present invention, the hint data includes application program usage type of the image screen and rules select compression techniques based on priority of usage type.

According to some embodiments of the present invention, the characteristics of optimal video quality streaming are detected from a video file that is streamed.

According to some embodiments of the present invention is provided a system for enhancing compression and transmission process of screen image that is generated by at least one application program that is running on a processing device, where said screen image is streamed from a mobile phone to a remote display

The system is comprised of:
a screen image data module for retrieving screen image data as generated by at least one application program;
a hint data module for retrieving in real time, hint data from at least one of the following: said applications and the operating system, wherein said hint data includes usage of data communication resources, usage characteristics of an application image or rendering data;
a design module for retrieving windows layout design information of all windows appearing at the image screen from the windows manager; and
a processing module for determining compression and transmission techniques of at least part of application that is displayed on the screen image by applying rules based on aggregated hint data per application program.

These, additional, and/or other aspects and/or advantages of the present invention are: set forth in the detailed description which follows; possibly inferable from the detailed description; and/or learnable by practice of the present invention.

### BRIEF DESCRIPTION OF DRAWINGS

FIG. 1 is a block diagram of a system for compression and transmission process of an application program, according to some embodiments of the invention;

FIG. 2 is a block diagram of a system that identifies repeated patterns through monitoring application resource usage in compression and transmission process of an application program, according to some embodiments of the invention;

FIG. 3 is a flow chart illustrating the method of enhancing compression and transmission process of a screen image generated by at least one application program, according to some embodiments of the invention;

FIG. 4 is a flow chart illustrating the method of cropping parts of a component with no change and sending a compression of the remainder, according to some embodiments of the invention;

FIG. 5 is a flow chart illustrating the method of identifying text in an image and sending it, according to some embodiments of the invention;

FIG. 6 is a flow chart illustrating the method of transmitting resources and later compressed references to the resources, according to some embodiments of the invention;

FIG. 7 is a flow chart illustrating the method of encoding differences in application image, according to some embodiments of the invention;

FIG. 8 is a flow chart illustrating the method of encoding an application by usage type, according to some embodiments of the invention, and

FIG. 9 is a block diagram of a screen image of a processing device that is running at least one application program, according to some embodiments of the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “widget” as used herein in this application, is defined as a component of an application Graphical User Interface (GUI), such as a window, a button or a scroll bar. A widget may be a container of other widgets.

The term “Widget Tool Kit” as used herein in this application, is defined as a code library which implements code that draws widgets. It is typically part of the GUI implementation code library.

The term “window manager” as used herein in this application, is defined as part of the implementation of a GUI library which is responsible for the positioning of different application windows with relation to the display surface or screen and to each other.

The term “window composer” as used herein in this application, is defined as part of the implementation of a GUI library which is responsible for composing all the different parts of the various applications' user interface into a single stream of bits in a format supported by the display hardware which represents the frame to display.

The term “Frame Buffer” as used herein in this application, is defined as a range of computer Random Access Memory (RAM) from which the display hardware reads the stream of bits representing the current frame to display. The data is written to the frame buffer by the Window Composer.

The term “codec” as used herein in this application, is defined as a Compressor/Decompressor. It is an algorithm for compressing information as well as the code that implements the algorithm. The data that is compressed may be a stream of visual images comprising the GUI of at least one application program.

The term “application framework” as used herein in this application, is defined as a software framework that may be used to implement a structure of an application program for a specific development environment.

The term “hint data” as used herein in this application, is defined as information that a codec engine or a processing unit may receive from an application program or operating system. The codec engine may take into account the information that is received and thus improve compression and transmission process. A processing unit may take into account information that is received and thus improve the way it uses a codec.

The term “resource” as used herein in this application, is defined as any data such as graphics or text that is stored as part of an application program and may be used by it during its execution. Most operating systems provide Application Programming Interface (API) for loading and reusing resources during application execution.

The term “resource reference” as used herein in this application, is defined as a reference that is given to a resource such as an icon in an application that was cached in advance.

The term “transition operation” as used herein in this application, is defined as an activity that changes content that is displayed on a screen. For example, scrolling i.e. sliding text or an image across a display.

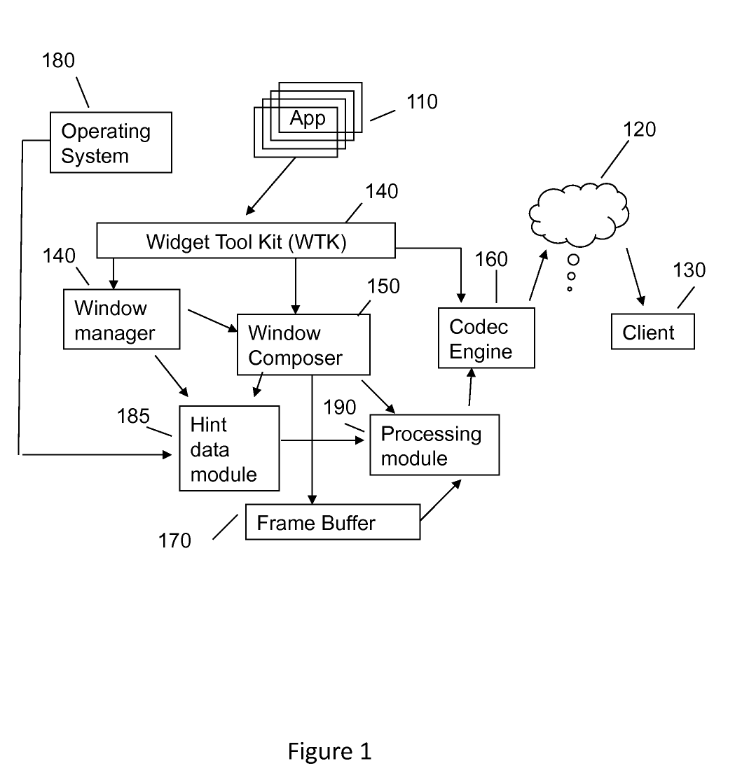

FIG. 1 is a block diagram of compression and transmission process of an application program, according to some embodiments.

According to some embodiments of the present invention, one or more applications 110 may use Widget Tool Kit (WTK) 140 to draw widgets. Each widget object/component may have attributes such as size, coordinates, type (such as text, video, and vector graphics) that may be assigned to it. The WTK 140 may provide information to a Window Manager (WM) 145 regarding generation windows and their state. The WM 145 may determine coordinates of several windows and may decide if a window needs to be redrawn because a new part of it is visible. The Window composer 150 may receive the relative window coordinates from the WM 145 and may use it to determine which part of the window may be visible on each location of the window.

In addition, the Codec Engine 160 may receive information from the WM 145 about the coordinates and size of each window. According to some embodiments of the present invention, the Codec Engine 160 may receive information i.e. hint data, from the Window composer 150 about which part of each window may be visible at any given time and which part of the Frame Buffer 170 may be updated in each frame that was generated. The information that may be received i.e. hint data, may be used by the Codec Engine 160 to decide which part of each frame has to be processed in order to recreate the frame at the client 130 side. In other words, the codec engine 160 may take into account the specific hint data provided to it and may not compress data of the invisible window. Thus, by receiving this type of data and other hint data, the compression and transmission process may be improved and battery energy in the processing device may be saved, for example, skipping on frames.

According to some embodiments the present invention, the codec engine 160 may include advanced performance capabilities of the processing module 190.

According to some embodiments of the present invention, the Codec Engine 160 may receive information from a processing module 190. The processing module 190 may determine compression and transmission techniques of at least part of application 110 that is displayed on the screen image by applying rules based on aggregated hint data per application program 110. Hint data may be received from a hint data module 185 that may retrieve in real time, information i.e. hint data from at least one of the following: said applications 110 and the operating system 180. The hint data may include (i) usage of data device resources (per application); (ii) usage characteristics of an application image; (iii) application layout data; or (iv) application type.

In a non limiting example, hint data may be: (i) video quality parameters such as: frame rate and resolution; (ii) content of text in an image containing text; (iii) forecast when an image or part of it is going to change; (iv) information how an image is created; and (v) data and logic of an application, for example, which in which frame rate to transmit or when a screen is about to shift.

The Window composer 150 may receive from the WTK 140 information such as (i) content of each window; or (ii) relative position or size; or (iii) content of various widgets that compose each window. The Window composer 150 may use the information to determine the content that may be displayed in each window.

In addition, the Window composer 150 may use all information described above to determine which part of a window stored in the Frame Buffer 170 has to be redrawn and renders that part of the window as a bitmap into the Frame Buffer 170.

The Codec Engine 160 may read the bitmap information of the part of the frame that was changed from previous frame from the Frame Buffer 170 using a memory copy or Direct Memory Access (DMA) operation. In addition, the Codec Engine 160 may receive from the WTK 140 information i.e. hint data about the type and other attributes of each widget in each window and may use the information to determine compression parameters for each widget in each window in the area of the Frame Buffer 170 that was updated in the last frame.

According to some embodiments of the present invention, SDK API allows application programmers to define program parameters (related to optimal image compression and transmission) in advance and change them during application execution. These parameters are gathered in real time and used as hint data.

According to some embodiments of the present invention, each application program that is displayed on the image screen may be compressed/encoded by the codec 160 engine and then a merge of all compressed/encoded application programs may be transmitted to the client side.

According to some embodiments of the present invention, the Codec Engine 160 produces a compressed stream of bits that encodes the relevant changes of each frame that are required to recreate the frame at the client 130 side at a defined quality, based on the compression parameters set for each part of the frame. The Codec Engine 160 may receive the compression parameters from the hint data module 185 via the processing module 190. Then, the compressed/encoded stream of bits may be transmitted via data communication network 120 to the client 130 side.

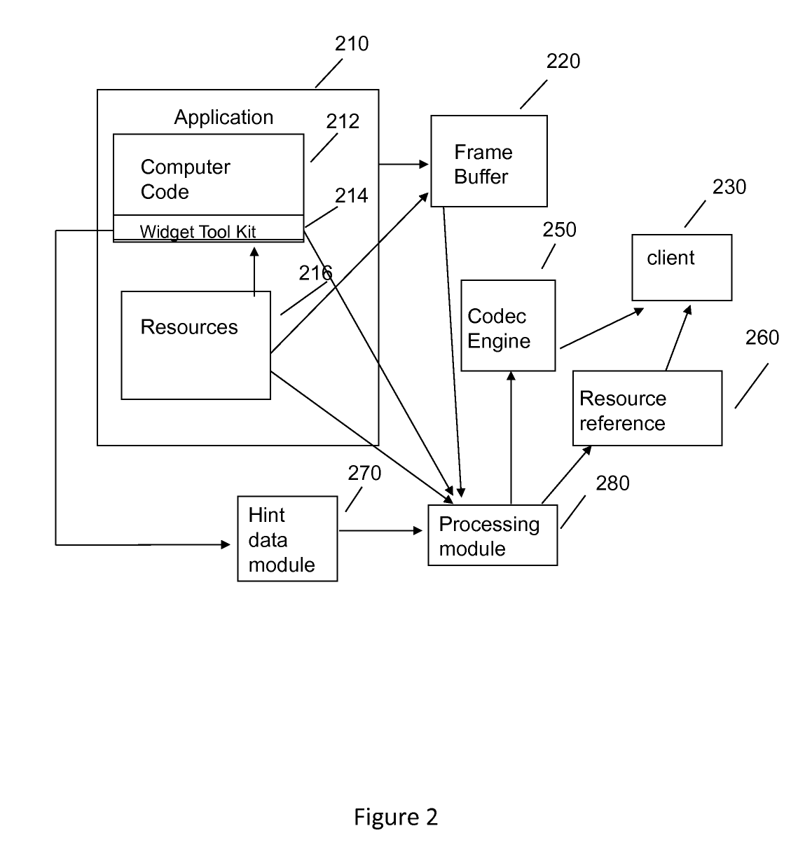

FIG. 2 is a block diagram of a system that identifies repeated patterns through monitoring application resource usage in compression and transmission process of an application program, according to some embodiments of the invention.

An application 210 may include a code 212 for execution and resources 216 that are being used by the computer code 212. The computer code 212 that is part of the application 210, may include external library code, such as Widget Tool Kit (WTK) 214, that may use graphical resources 216 of the application 210.

According to some embodiments of the present invention, in a non-limiting example, the running code 212 may utilize a bitmap image file from resources 216 using memory allocated by an operating system. Then the bitmap image may be rendered by the code 212 into a Frame Buffer 220 as part of an Application User Interface (API). The WTK 214 may contain hooks that may provide information to Hint data module 270. The Codec Engine 250 may be notified about the hint data via processing module 280, regarding any access to resources 216 by the code 212 of the application 210.

In a non-limiting example, the resources 216 of the application 210 may include icons, image files, bitmap files, vector graphics files and any other graphical resource that may be rendered in whole or in part as part of the application's User Interface (UI). The Codec Engine 250 may read the rendered UI Frame Buffer 220 via from the processing module 280 and encodes it into a stream of compressed frames.

According to some embodiments of the present invention, the Codec Engine 250 may use information about (i) the resources 216 that the application 210 accessed via the code 212; (ii) the relative location in the application UI; and (iii) the frequency of the resource 216 usage, to create resource reference 260. The information may be collected by the hint data module 270 and processed by the processing module 280. Resource reference 260 may contain a representation of graphical display of the resources 216 that are being used by the application 210. The resource reference 260 may be used to be sent to the client 230 side instead of transmitting compressed/encoded resources 216 when being called by the application code 212.

According to some embodiments of the present invention, hint data that was collected by hint data module 270 and processed by processing module 280 may be forwarded to a Codec Engine 250. The hint data may include stored information of repeating patterns in screen images in an application 210 and rules including instructions for caching repeated patterns at the target display screen. Resources may be an example of repeated patterns. The resource reference 260 may be sent to the client 230 and codec engine 250 may transmit encoded information to the client 230. Resources 216 which are part of application 210, in a non-limiting example, icons, may be transmitted to the client 230 and while application 210 is running when it is using one of the icons, the transmitted screen images excludes the repeating patterns i.e. resources 216 and send only its reference number.

According to some embodiments of the present invention, the Codec Engine 250 may retrieve screen image and metadata information from the application programs 210 via hint data module 270 and processing module 280. The metadata information which is a type of hint data, may include characteristics and attributes of different areas i.e. components in the image screen data. The characteristics may include information of the component image type (e.g. still image, Video, text etc.) retrieved from the WTK 214, bounding border hint information retrieved from the widgets' codes 212 or information about the data resources 216 and its usage pattern by each application 210.

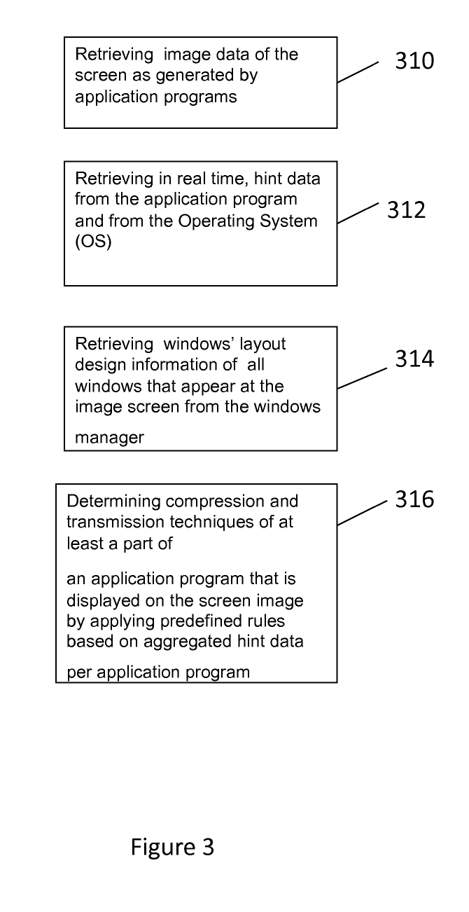

FIG. 3 is a flow chart illustrating a method of enhancing compression and transmission process of a screen image generated by at least one application program, according to some embodiments of the invention. By enhancing and improving the process of compression and transmission, battery energy in a processing device that at least one application program is running on it, may be saved as well as other computer resources. According to some embodiments of the present invention, the method starts with retrieving image data of the screen as generated by application programs (step 310). In a non limiting example, the image data of the screen may be composed of a web application, an image with text content, an online game application and a background picture. Next, retrieving in real time, hint data from the application program and from the Operating System (OS) (step 312). Hint data may be collected by a hint data module 185 in FIG. 1 and processed by processing module 190 in FIG. 1. For example, when a user scrolls a page in the web application the web application may notify the hint data module 185 on an image change. Another example, the online game application may notify the hint data module 185 on predicted image change with no user intervention. Yet, another example, hint data module 185 in FIG. 1 may identify an image that contains text and forward it to processing module 190 to digest the text content. Next, retrieving windows' layout design information of all windows that appear at the image screen from the windows manager (step 314) Next, determining compression and transmission techniques of at least a part of an application program that is displayed on the screen image by applying predefined rules based on aggregated hint data per application program (step 316). For example, compressing/encoding only changes in the display of the web application or online game application and transmitting to the client the compressed/encoded changes. Another example, compressing and transmitting to the client only the text content that is in the image with text content.

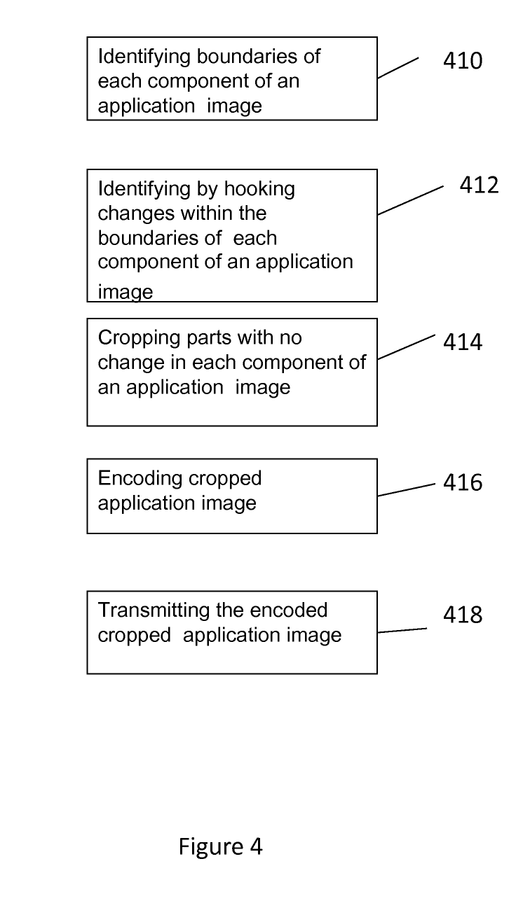

FIG. 4 is a flow chart illustrating the method of cropping parts of a component with no change and sending compression of the remainder, according to some embodiments of the invention. According to some embodiments of the present invention, the method starts with identifying boundaries of each component of an application image (step 410). Next, identifying by hooking, changes within the boundaries of each component of an application image (step 412). The changes may be in frames of images of an application. Next, cropping parts with no change in each component of an application image (step 414). Next, encoding cropped application image (step 416). Next, transmitting the encoded cropped application image (step 418). Meaning, providing a codec engine rules including instructions to skip compression and transmission of a frame image when no change is identified. For example, in an image frame that consists of two lines of text and then a third line of text is being added, the two lines of text may be cropped and only the third line of text that was added may be compressed/encoded and transmitted to a client side.

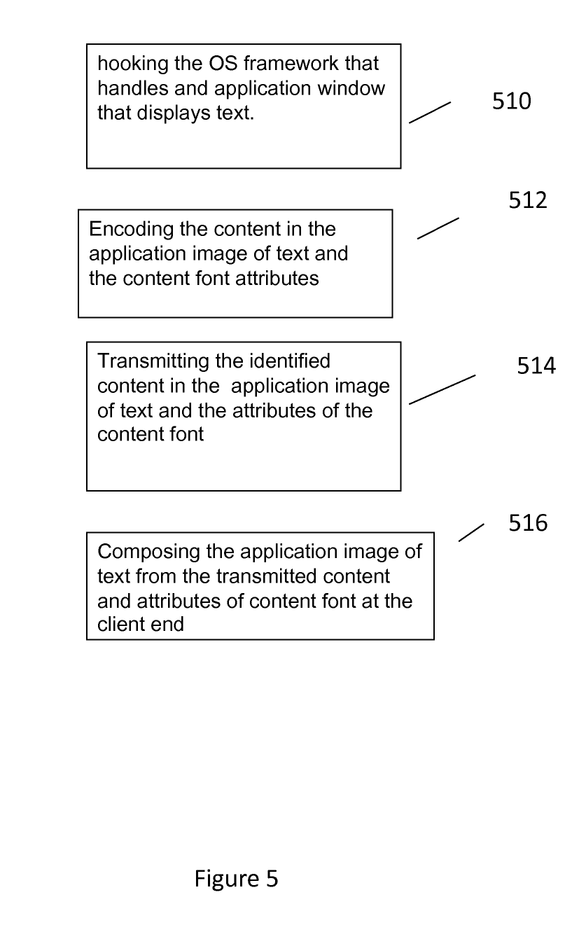

FIG. 5 is a flow chart illustrating the method of identifying text in an image and sending it, according to some embodiments of the invention. According to some embodiments of the present invention, the method starts with hooking the OS framework that handles and application window that displays text. From this hook the text itself and the content font attributes are retrieved (step 510). The identification of application image changes may be achieved by hooking, utilizing an Operating System (OS) mechanism that may provide content related information of the application image. In a non limiting example, one of the applications that may run on a screen image of a processing device may display an image containing text such as in Google books online. Hint data module 185 in FIG. 1 may collect identified/hooked data and forward it to a processing module 190 in FIG. 1. Next, encoding the content in the application image of text and the content font attributes (step 512). Next, transmitting the identified content in the application image of text and the attributes of the content font (step 514). The codec engine 160 may transmit compressed/encoded content. Next, composing the application image of text from the transmitted compressed/encoded content and attributes of content font at the client's end 130 in FIG. 1 (step 516). Additionally, the OS hooks on User Interface such as views and control that are composing an application window and rules may include instructions to skip parts in the application program that were not changed.

In a non limiting example, the Codec Engine may choose a codec that is “friendly” to sequences of a few colors with sharp transitions, such as RLE or ZRLE to compress the image data in the area rendered by this component/widget. Another optimization that The Codec Engine may implement is by using the observation that while the image data in the area rendered by this component/widget may change rapidly, most of the changes will be copies of existing blocks of data with an offset in the Y axis, due to scrolling and optimize macro blocks vector shift searches of codecs such as MPEG4 or V8 to only look for vector shifts in this direction.

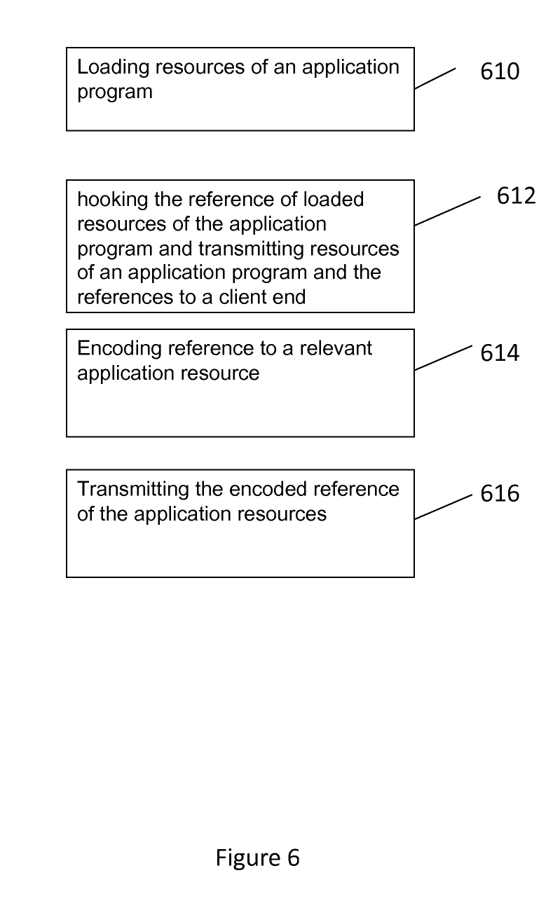

FIG. 6 is a flow chart illustrating the method of transmitting resources and later compressed references to the resources, according to some embodiments of the invention.

According to some embodiments of the present invention, the method starts with loading resources of an application program (step 610). The resources of the application program as well as repeated patterns in a screen images may be compressed/encoded and transmitted to the client 130 in FIG. 1 side, preemptively. Next, hooking a reference of the loaded resources of the application program and repeated patterns and transmitting it to a client end 130 in FIG. 1 (step 612). Next, encoding reference to a relevant application resource (step 614). And finally, transmitting the encoded reference of the application resources (step 616). In a non limiting example, an application program that is running on a processing device and displays several icons as part of its menus and user's interface. Instead of compressing/encoding the icon each time the application program is using the icon, the icons are sent to the client side 130 in FIG. 1 in advance. Then, each time the application program uses an icon only a reference to it is sent to the client side 130 in FIG. 1. Thus, improving compression and transmission process and saving energy of a battery of the processing device as it saves usage of the codec engine.

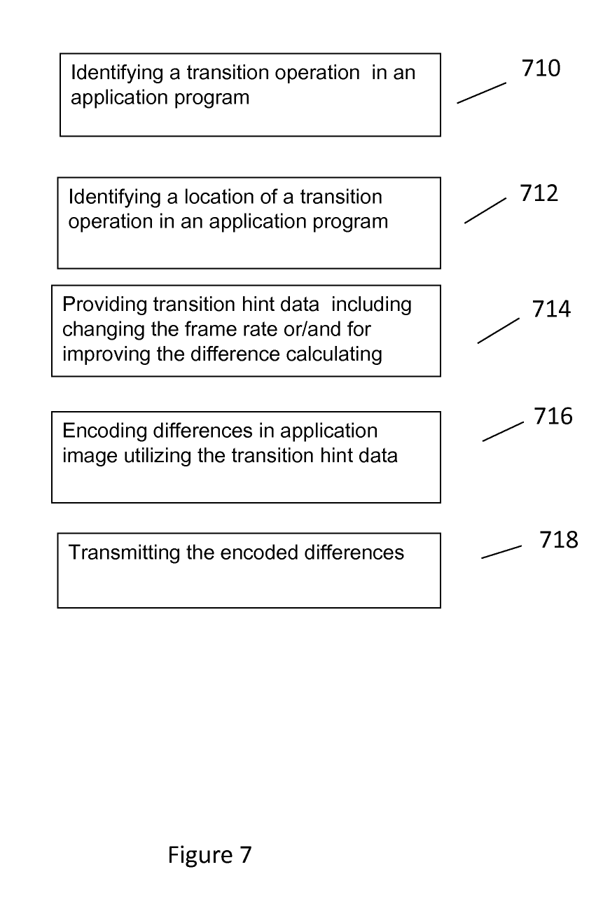

FIG. 7 is a flow chart illustrating the method of encoding differences in application image, according to some embodiments of the invention. According to some embodiments of the present invention, the method starts with identifying a transition operation in an application program (step 710). In a non-limiting example, transition operation may be performed by either a user that rolled a scroll bar or automatically by an application program. Therefore, much of the changes in an image of the application may be copies of existing blocks of data with an offset in the Y axis, due to the scrolling or the automatic roll of the application program. Therefore, hint data module 185 in FIG. 1 may specify the codec the direction of the transition operation. Next, identifying a location of a transition operation in an application program (step 712). Next, providing transition hint data including changing the frame rate or/and for improving the difference calculating (step 714) to the codec engine 160 in FIG. 1. For example, reducing frame rate during transition operation when quality is less important and then, after transition operation ends sending in a higher frame rate. Next, encoding differences in application's image utilizing the transition hint data (step 716). And finally transmitting the encoded differences to the client (step 718).

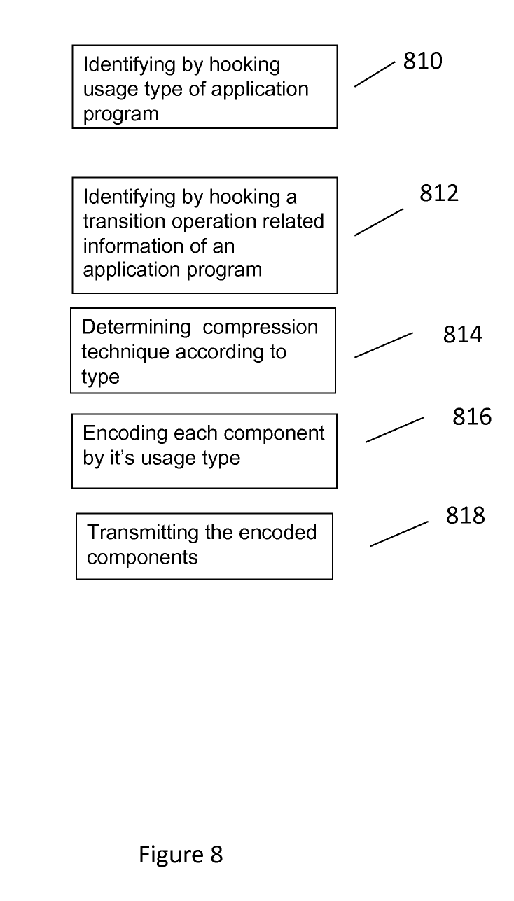

FIG. 8 is a flow chart illustrating the method of encoding an application by its usage type, according to some embodiments of the invention.

According to some embodiments of the present invention, the method starts with identifying by hooking usage type of an application program (step 810). Next,

identifying by hooking a transition operation related information of an application program (step 812). Next, determining compression technique according to usage type (step 814). Next, encoding each component by its usage type (step 816). And finally transmitting the encoded components (step 818).

For example, hint data regarding usage of web application or a video may affect the compression technique. A web application may be written in HTML code embedded with PHP code and will be compressed/encoded in a different technique than a video that is composed of a sequence of frames. In video display, frame rate and resolution parameters are the most important characteristics that should be taken into account. Therefore, the Codec Engine may choose a video codec such as MPEG4 or V8 to handle parts of the screen image rendered by this component/widget. In addition, the Codec Engine can expect that these parts of the display will change rapidly, therefore a trade off of low bandwidth over higher quality may be preferred, for two reasons: (i) because the user will see every frame for a brief period of time and will thus not be sensitive to details; and (ii) because the frame data of that part will need to be sent numerous times in high rate. Such a trade off will may be implemented by, for example, choosing Discrete Cosine Transform (DCT) quantization and chroma parameters that leave out image fine details and color information in favor of higher compression rate. Whereas in usage of web application other parameters such as moving a window in a certain direction i.e. transition operation should be taken into account and only parts of the image that were changed should be transferred.

According to some embodiments of the present invention, hint data may include characteristics of optimal video quality of video so that an application that may be streamed in a certain frame rate in a certain time, may be encoded at this specific rate. Thus, quality of image is not deteriorated, and other resources such as Central Processing Unit (CPU), battery and bandwidth are not wasted. The characteristics of optimal video quality may be taken from external network performance parameters so compression rules that include calculation of maximal frame rate and other related parameters in real time may take these characteristics into account.

According to some embodiments of the present invention, an additional method to get frame rate data is by inserting it in Application Programming Interface (API) by application developers. Alternatively, the parameters may be detected from OS hooks.

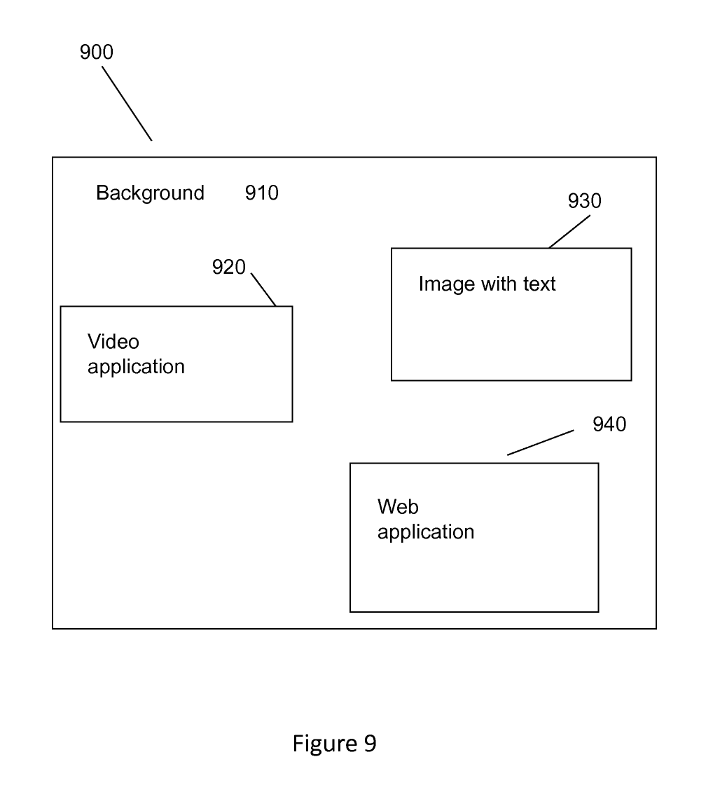

FIG. 9 is a block diagram of a screen image of a processing device that is running at least one application program, according to some embodiments of the invention.

According to some embodiments of the present invention, hint data that is collected by the hint module 185 may include characteristics of each application program that may appear on the screen image. The hint data may be forwarded to the codec engine 160 via the processing module 190 and compression rules may be determined by optimization of compression and transmission but may take into account quality of image of certain application programs such as video.

According to some embodiments of the present invention, in a non limiting example, when screen image 900 displays video application 920, image with text 930 and web application 940 over background 910 priorities may be predefined or dynamically attributed to determine which compression technique to favor by the priority of the application programs that are displayed on the image screen or by their usage type. For example, a window that requires high frame rate but was marked in lower priority may be ignored i.e. would not be provided with high frame rate. In another example, a window that was changed will be updated later on and not immediately when it is attributed with low priority.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A method for enhancing compression and transmission process of a screen image generated by at least one application program running on a processing device, wherein said screen image is streamed from a processing device to a remote display, said method comprising the steps of:
retrieving screen image data as generated by at least one application program;
retrieving in real time, hint data from at least one of the following: said application programs and the operating system, wherein said hint data include: (i) usage of data device resources per application; (ii) usage characteristics of an application image; (iii) application layout data; or (iv) application type;
retrieving windows' layout design information of all windows that appear at the image screen from a windows manager, and
determining compression and transmission techniques of at least a part of an application program that is displayed on the screen image by applying predefined rules based on aggregated hint data per application program.

2. The method of claim 1, wherein the usage characteristics of the application image includes identification of changes of the application image (frame), and respective rules including instructions to skip transmission of a frame image when no change is identified.

3. The method of claim 2, wherein identification of application image changes is achieved by hooking an Operating System (OS) mechanism which provides content related information of the application image.

4. The method of claim 2, wherein the identification of application image changes is achieved by OS hooks on User Interface (UI) framework such as views and control composing the application window and rules including instructions to skip partial areas of the application image in which no change is identified.

5. The method of claim 1, wherein the hint data includes application program usage type of the image screen and rules to select compression techniques based on usage type.

6. The method of claim 5, wherein application program usage includes transition operation related information and rules include instruction of changing compression and transmission parameters.

7. The method of claim 6, wherein the identification of transition operation is achieved by OS hooks in the UI framework of Android OS.

8. The method of claim 6, wherein the identification of transition operation is achieved by receiving application program's hint data.

9. The method of claim 6, wherein the identification of transition operation includes information of transition direction.

10. The method of claim 1, wherein the hint data include characteristics of optimal video quality of video which includes the screen image, and rules including transmission and compression instructions adapted to characteristics of optimal video quality.

11. The method of claim 10, wherein the characteristics of optimal video quality streaming are detected from an external network performance parameters, and the rules include calculation of the maximal frame rate and other related parameters in real time and adjust compression parameters accordingly.

12. The method of claim 10, wherein the characteristics of optimal video quality streaming are detected from OS hooks.

13. The method of claim 1, wherein an SDK API allows application programmers to define program parameters related to optimal image compression and transmission in advance and change these program parameters during application program execution, wherein these parameters are gathered in real time and used as hint data.

14. The method of claim 1, wherein the hint data includes repeating patterns in the screen images hooked from the OS and the applications and wherein the rules includes instructions for caching repeated patterns at the target display and identifying repeated patterns by reference number, hence the transmitted screen images excludes the repeating patterns and send only its reference number.

15. The method of claim 14, wherein information of repeating patterns in the screen images is received from OS hooks with no application program intervention.

16. The method of claim 1, wherein the hint data includes specific characteristic for each component or each application program that appears on the screen images and the compression rules are determined by at least one of: (i) optimizing the compression and transmission performance parameters; and (ii) screen images' quality by taking into account the hint data of all screens areas and application programs and OS hint information of windows layout, wherein the optimization include prioritizing between the compression and transmission parameters of the different components and applications and determining unified compression and transmission parameters for the whole screen image.

17. The method of claim 16, wherein different priorities are defined for all components and application programs that appear on the screen image.

18. The method of claim 16, wherein different priorities are calculated in real time according to hint data for all components and application programs that appear on the screen image.

19. The method of claim 1, wherein the transmission technique further includes splitting application windows compressing each application and transmitting to the client side and merging of all compressed images of application programs at the client side.

20. The method of claim 1, wherein the hint data includes application program usage type of the image screen and rules select compression techniques based on usage type and priority, and wherein usage type and priority may be changed in real time during application program execution.

21. The method of claim 10, wherein the characteristics of optimal video quality streaming are detected from a video file that is streamed.

22. A system for enhancing compression and transmission process of screen image that is generated by at least one application program that is running on a processing device, where said screen image is streamed from a mobile phone to a remote display, said system is comprised of:
a screen image data module for retrieving screen image data as generated by at least one application program;
a hint data module for retrieving in real time, hint data from at least one of the following: said applications and the operating system, wherein said hint data includes usage of data communication resources, usage characteristics of an application image or rendering data;
a design module for retrieving windows layout design information of all windows appearing at the image screen from the windows manager; and
a processing module for determining compression and transmission techniques of at least part of application that is displayed on the screen image by applying rules based on aggregated hint data per application program.
